(19) United States
(12) Patent Application Publication
(10) Pub. No.: US 2020/0097098 A1
(43) Pub. Date: Mar. 26, 2020

(54) VIRTUAL KEYBOARD IMPLEMENTATION METHOD, STORAGE DEVICE, AND MOBILE TERMINAL

(71) Applicant: JRD COMMUNICATION (SHENZHEN) LTD, SHENZHEN (CN)

(72) Inventors: YONGQIU ZHU, SHENZHEN (CN); BIN Luo, SHENZHEN (CN)

(21) Appl. No.: 16/619,079

(22) PCT Filed: Jun. 19, 2018
(86) PCT No.: PCT/CN2018/091849

§ 371 Date: Dec. 3, 2019

(30) Foreign Application Priority Data
Jun. 19, 2017 (CN) 201710463142.5

(51) Int. Cl. G06F 3/023; G06F 3/0488; G06F 1/16

(52) U.S. Cl. CPC G06F 3/0231; G06F 1/1698; G06F 3/0233; G06F 3/04886

(57) ABSTRACT

The present disclosure provides a virtual keyboard implementation method suitable for being executed in a mobile terminal. The method includes: starting a virtual keyboard, and displaying a virtual keyboard interface; sending a wireless connection signal to an external device, and establishing a connection with the external device; sending a key-press signal of the virtual keyboard to the external device which executes a corresponding key-press response according to the key-press signal. The present disclosure also provides a storage device and a mobile terminal, having stored therein multiple instructions suitable for being loaded and executed by a processor. The instructions include: starting a virtual keyboard, and displaying a virtual keyboard interface; sending a wireless connection signal to an external device, and establishing a connection with the external device; and sending a key-press signal of the virtual keyboard to the external device which executes a corresponding key-press response according to the key-press signal.

### TECHNICAL FIELD

The present disclosure relates to electronic products, particularly to a virtual keyboard implementation method, a storage device, and a mobile terminal.

### BACKGROUND

A keyboard used in a current mobile phone or tablet computer typically uses a virtual keyboard belonging to the mobile phone or tablet computer itself, or an external Bluetooth keyboard. The external Bluetooth keyboard, as a separate accessory, usually needs to be purchased and is not convenient to carry outdoors. Moreover, since its own virtual keyboard usually occupies only such a small part of the display area of the screen that keys of the keyboard are too small, there are such problems as small operation space and inconveniences in operation with two hands. The tablet computer, due to its own portability, gradually takes the place of a notebook computer. However, operation space of the virtual keyboard of the tablet computer is so small that great inconveniences are caused during its use; and carrying an external Bluetooth keyboard not only increases the weight, but also reduces portability of the tablet computer.

### SUMMARY

To overcome the deficiencies of the prior art, the present disclosure provides a virtual keyboard implementation method, a storage device, and a mobile terminal, so as to replace the external Bluetooth keyboard.

The present disclosure provides a virtual keyboard implementation method adapted to be executed in a mobile terminal, wherein the method includes:

starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

Further, prior to said sending a wireless connection signal to an external device, the method further determines whether to disable other function services than the virtual keyboard and network services. If yes, the other function services are disabled and a power-saving mode is entered; otherwise, they are not disabled.

Further, the wireless connection is a Bluetooth connection.

Further, said starting a virtual keyboard and displaying a virtual keyboard interface is specifically: displaying the virtual keyboard in full screen after starting the virtual keyboard.

Further, said sending a key-press signal of the virtual keyboard to the external device is specifically: after pressing key-press operation on the virtual keyboard, packaging key-press codes into a key-press signal and sending it to the external device, wherein the external device decompresses the key-press signal and then displays corresponding characters according to a sequence of the key-press codes.

Further, the external device is a mobile terminal.

The present disclosure further provides a storage device having stored therein a plurality of instructions adapted to be loaded and executed by a processor, wherein the instructions include:

starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

Further, prior to said sending a wireless connection signal to an external device, the instructions further include determining whether to disable other function services than the virtual keyboard and network services. If yes, the other function services are disabled and a power-saving mode is entered; otherwise, they are not disabled.

The present disclosure further provides a mobile terminal, including: a processor configured to implement various instructions; and a storage device configured to store a plurality of instructions for being loaded and executed by the processor, wherein the instructions include:

starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

Further, prior to said sending a wireless connection signal to an external device, the instructions further include determining whether to disable other function services than the virtual keyboard and network services. If yes, the other function services are disabled and a power-saving mode is entered; otherwise, they are not disabled.

Compared with the prior art, the present disclosure realizes an input operation of the keyboard by connecting the mobile terminal as a virtual keyboard to the external device, thereby replacing the external Bluetooth keyboard, increasing the function of the mobile terminal, and solving the problem concerning carrying the external Bluetooth keyboard.

### BRIEF DESCRIPTION OF THE DRAWINGS

FIG. 1 is a flow chart diagram according to the present disclosure.

FIG. 2 is a schematic diagram of displaying of a virtual keyboard of in a mobile terminal according to the present disclosure.

FIG. 3 is a structural block diagram of an embodiment of a virtual keyboard implementation method according to the present disclosure.

### DETAILED DESCRIPTION

The present disclosure will be further described in detail below in conjunction with the accompanying drawings and embodiments.

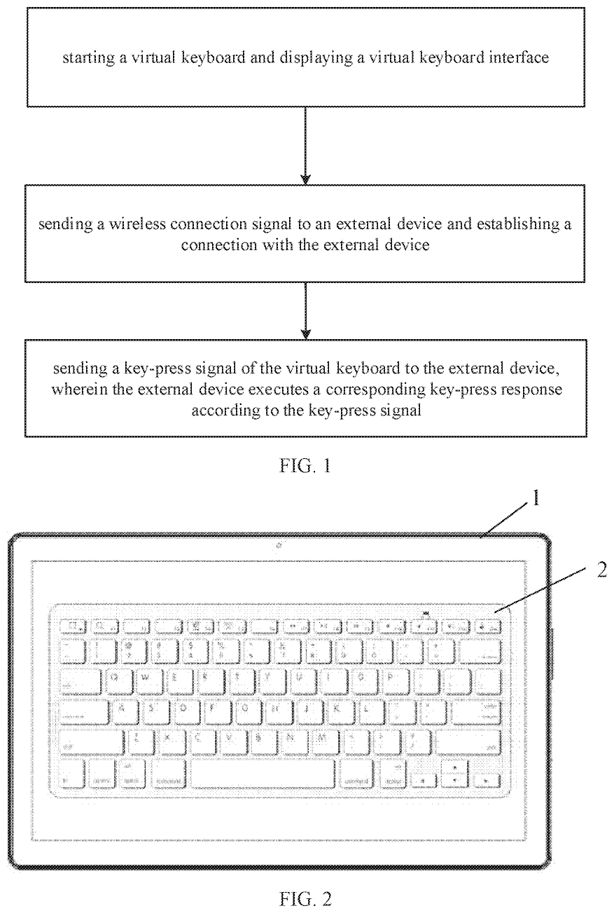

As shown in FIG. 1, a virtual keyboard implementation method according to the present disclosure, which is adapted to be executed in a mobile terminal, includes the following.

A virtual keyboard is started and a virtual keyboard interface is displayed. Specifically, the virtual keyboard interface is displayed in a full-screen manner (as shown in FIG. 2). In FIG. 2, the reference number 1 represents a mobile terminal, and the reference number 2 represents a virtual keyboard interface.

A wireless connection signal is sent to an external device and a connection with the external device is established. Specifically, the external device is another mobile terminal. It is worth noting that one of the mobile terminals in the present disclosure is used as an external Bluetooth keyboard of the external device to replace the traditional external Bluetooth keyboard. The wireless connection is a Bluetooth connection. After the virtual keyboard interface is displayed, the external device obtains a sent Bluetooth broadcast via Bluetooth search and pairs with it. After the matching is successful, input of the virtual keyboard may be performed.

A key-press signal of the virtual keyboard is sent to the external device, and the external device executes a corresponding key-press response according to the key-press signal. Specifically, after key-press operation is pressed on the virtual keyboard, key-press codes are packaged into a key-press signal and sent to the external device, and the external device decompresses the key-press signal before displaying corresponding characters according to a sequence of the key-press codes. It is worth noting herein that the input key-press codes may be key-press codes required for Chinse input Pinyin, five strokes, and the like, and are not specifically limited herein.

According to an embodiment, before a wireless connection signal is sent to an external device, it is further determined whether to disable other function services than the virtual keyboard and network services. If yes, the other function services are disabled and a power-saving mode is entered. Otherwise, the other function services are not disabled. Specifically, the network service is a Bluetooth service, and the other devices include system applications or services.

In the present disclosure, the external device is a mobile terminal.

The present disclosure further discloses a storage device having stored therein a plurality of instructions adapted to be loaded and executed by a processor. The instructions include the following.

A virtual keyboard is started and a virtual keyboard interface is displayed. Specifically, the virtual keyboard interface is displayed in a full-screen manner (as shown in FIG. 2).

A wireless connection signal is sent to an external device and a connection with the external device is established. Specifically, the external device is another mobile terminal. It is worth noting that one of the mobile terminals in the present disclosure is used as an external Bluetooth keyboard of the external device to replace the traditional external Bluetooth keyboard. The wireless connection is a Bluetooth connection. After the virtual keyboard interface is displayed, the external device obtains a sent Bluetooth broadcast via Bluetooth search and pairs with it. After the matching is successful, input of the virtual keyboard may be performed.

A key-press signal of the virtual keyboard is sent to the external device, and the external device executes a corresponding key-press response according to the key-press signal. Specifically, after key-press operation is pressed on the virtual keyboard, key-press codes are packaged into a key-press signal and sent to the external device, and the external device decompresses the key-press signal before displaying corresponding characters according to a sequence of the key-press codes. It is worth noting herein that the input key-press codes may be key-press codes required for Chinse input Pinyin, five strokes, and the like, and are not specifically limited herein.

According to an embodiment, before a wireless connection signal is sent to an external device, it is further determined whether to disable other function services than the virtual keyboard and network services. If yes, the other function services are disabled and a power-saving mode is entered. Otherwise, the other function services are not disabled. Specifically, the network service is a Bluetooth service, and the other devices include system applications or services.

The present disclosure further discloses a mobile terminal, including a processor configured to implement various instructions; and a storage device configured to store a plurality of instructions for being loaded and executed by the processor. The instructions include the following.

A virtual keyboard is started and a virtual keyboard interface is displayed. Specifically, the virtual keyboard interface is displayed in a full-screen manner (as shown in FIG. 2).

A wireless connection signal is sent to an external device and a connection with the external device is established. Specifically, the external device is another mobile terminal. It is worth noting that one of the mobile terminals in the present disclosure is used as an external Bluetooth keyboard of the external device to replace the traditional external Bluetooth keyboard. The wireless connection is a Bluetooth connection. After the virtual keyboard interface is displayed, the external device obtains a sent Bluetooth broadcast via Bluetooth search and pairs with it. After the matching is successful, input of the virtual keyboard may be performed.

A key-press signal of the virtual keyboard is sent to the external device, and the external device executes a corresponding key-press response according to the key-press signal. Specifically, after key-press operation is pressed on the virtual keyboard, key-press codes are packaged into a key-press signal and sent to the external device, and the external device decompresses the key-press signal before displaying corresponding characters according to a sequence of the key-press codes. It is worth noting herein that the input key-press codes may be key-press codes required for Chinse input Pinyin, five strokes, and the like, and are not specifically limited herein.

According to an embodiment, before a wireless connection signal is sent to an external device, it is further determined whether to disable other function services than the virtual keyboard and network services. If yes, the other function services are disabled and a power-saving mode is entered. Otherwise, the other function services are not disabled. Specifically, the network service is a Bluetooth service, and the other devices include system applications or services.

Operation procedures of the present disclosure will be explained below by combining the mobile terminal with the virtual keyboard implementation method of the present disclosure.

By entering system setting of the mobile terminal or clicking an APP icon, it is possible to start a virtual keyboard and display a virtual keyboard interface. Specifically, the virtual keyboard interface is displayed in a full-screen manner (as shown in FIG. 2).

At this time, the virtual keyboard interface may display selection information “whether to disable other functions than the virtual keyboard”. The processor determines whether to disable other function services than the virtual keyboard and network services according to the user's selection. If yes, the other function services are disabled and a power-saving mode is entered. Otherwise, the other function services are not disabled. Specifically, the network service is a Bluetooth service, and the other services include system applications or services.

The processor controls the mobile terminal to send a Bluetooth broadcast to an external device and to establish a connection with the external device. Specifically, the external device is another mobile terminal. After the virtual keyboard interface is displayed, the external device obtains the sent Bluetooth broadcast via Bluetooth search and pairs with it. After the matching is successful, input of the virtual keyboard may be performed.

A key-press signal of the virtual keyboard is sent to the external device, and the external device executes a corresponding key-press response according to the key-press signal. Specifically, after key-press operation is pressed on the virtual keyboard, key-press codes are packaged into a key-press signal and sent to the external device, and the external device decompresses the key-press signal before displaying corresponding characters according to a sequence of the key-press codes. It is worth noting herein that the input key-press codes may be key-press codes required for Chinse input Pinyin, five strokes, and the like, and are not specifically limited herein.

The present disclosure may further configure an appearance of the virtual keyboard, and your own favorite virtual keyboard appearance may be selected accordingly.

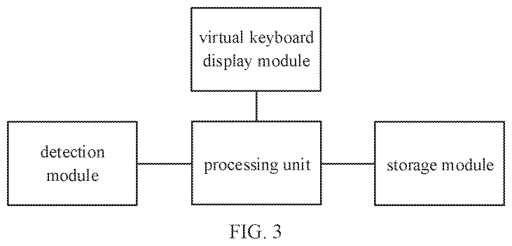

As shown in FIG. 3, a virtual keyboard device according to the present disclosure includes:

a virtual keyboard display module, configured to display a virtual keyboard;
a processing unit, configured to send a key-press signal to an external device;
a storage module, configured to record historical connection information and record user configuration information; and
a detection module, configured to send a wireless network signal and establish a connection, after starting the virtual keyboard.

The processing unit is further configured to determine whether the user disables other function services than the virtual keyboard and network services. If yes, the other function services are disabled and a power-saving mode is entered. Otherwise, the other function services are not disabled.

The external device is configured to receive the key-press signal and execute a corresponding key-press response according to the key-press signal.

Sending a key-press signal to an external device is specifically that: the processing unit, after key-press operation is pressed on the virtual keyboard, packages key-press codes into a key-press signal and send it to the external device which decompresses the key-press signal before displaying corresponding characters according to a sequence of the key-press codes.

By using a mobile terminal as an input device of another mobile terminal, the present invention improves a usage rate of the mobile terminal, without having to additionally carry an external Bluetooth keyboard to pair therewith, thereby reducing the weight load.

Although the invention has been shown and described with reference to the specific embodiments, persons skilled in the art may understand that: various changes to the forms and details may be made herein, without departing from the spirit and scope of the invention defined in the claims and equivalents thereof.

1. A storage device having stored therein a plurality of instructions adapted to be loaded and executed by a processor, wherein the instructions comprise:
starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

2. A virtual keyboard implementation method adapted to be executed in a mobile terminal, wherein the method comprises:
starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

3. The virtual keyboard implementation method according to claim 2, comprising: prior to said sending a wireless connection signal to an external device, further determining whether to disable other function services than the virtual keyboard and network services; if yes, disabling them and entering a power-saving mode; otherwise, not disabling them.

4. The virtual keyboard implementation method according to claim 2, wherein the wireless connection is a Bluetooth connection.

5. The virtual keyboard implementation method according to claim 2, wherein said starting a virtual keyboard and displaying a virtual keyboard interface is specifically: displaying the virtual keyboard in full screen after starting the virtual keyboard.

6. The virtual keyboard implementation method according to claim 2, wherein said sending a key-press signal of the virtual keyboard to the external device is specifically: after pressing key-press operation on the virtual keyboard, packaging key-press codes into a key-press signal and sending it to the external device, the external device decompressing the key-press signal before displaying corresponding characters according to a sequence of the key-press codes.

7. The virtual keyboard implementation method according to claim 2, wherein the external device is a mobile terminal.

8. The virtual keyboard implementation method according to claim 3, wherein the external device is a mobile terminal.

9. The virtual keyboard implementation method according to claim 4, wherein the external device is a mobile terminal.

10. The virtual keyboard implementation method according to claim 5, wherein the external device is a mobile terminal.

11. The virtual keyboard implementation method according to claim 6, wherein the external device is a mobile terminal.

12. A mobile terminal, comprising: a processor, configured to implement various instructions; and a storage device, configured to store a plurality of instructions for being loaded and executed by the processor; the instructions comprising:
starting a virtual keyboard and displaying a virtual keyboard interface;
sending a wireless connection signal to an external device and establishing a connection with the external device; and
sending a key-press signal of the virtual keyboard to the external device, wherein the external device executes a corresponding key-press response according to the key-press signal.

13. The mobile terminal according to claim 12, wherein: prior to said sending a wireless connection signal to an external device, the instructions further comprise determining whether to disable other function services than the virtual keyboard and network services; if yes, the other function services are disabled and a power-saving mode is entered; otherwise, they are not disabled.

14. The storage device according to claim 1, wherein: prior to said sending a wireless connection signal to an external device, the instructions further comprise determining whether to disable other function services than the virtual keyboard and network services; if yes, disabling them and entering a power-saving mode; otherwise, not disabling them.

15. The storage device according to claim 1, wherein the wireless connection is a Bluetooth connection.

16. The storage device according to claim 1, wherein said starting a virtual keyboard and displaying a virtual keyboard interface is specifically: displaying the virtual keyboard in full screen after starting the virtual keyboard.

17. The storage device according to claim 1, wherein said sending a key-press signal of the virtual keyboard to the external device is specifically: after pressing key-press operation on the virtual keyboard, packaging key-press codes into a key-press signal and sending it to the external device, the external device decompressing the key-press signal before displaying corresponding characters according to a sequence of the key-press codes.

18. The storage device according to claim 1, wherein the external device is a mobile terminal.

19. The mobile terminal according to claim 12, wherein said starting a virtual keyboard and displaying a virtual keyboard interface is specifically: displaying the virtual keyboard in full screen after starting the virtual keyboard.

20. The mobile terminal according to claim 12, wherein said sending a key-press signal of the virtual keyboard to the external device is specifically: after pressing key-press operation on the virtual keyboard, packaging key-press codes into a key-press signal and sending it to the external device, the external device decompressing the key-press signal before displaying corresponding characters according to a sequence of the key-press codes.
